(19) United States
(12) Patent Application Publication
(10) Pub. No.: US 2011/0310102 A1
(43) Pub. Date: Dec. 22, 2011

(54) SYSTEMS AND METHODS FOR SUBDIVIDING AND STORING VERTEX DATA

(75) Inventor: Hua-Yu Chang, Taipei County (TW)

(73) Assignee: VIA TECHNOLOGIES, INC., Hsin-Tien, Taipei (TW)

(21) Appl. No.: 12/817,294

(22) Filed: Jun. 17, 2010

(51) Int. Cl. G06T 17/20

(52) U.S. Cl. 345/423

(57) ABSTRACT

Systems and methods for subdividing patches and storing control points are described. At least one embodiment is a method for storing vertex data in a graphics processor. The method comprises receiving a patch to be tessellated, subdividing the patch into a plurality of triangles, and identifying control points of each of the plurality of triangles. The method further comprises assigning an identifier to each of the vertices, and selectively storing only a portion of the vertices in a memory.

### TECHNICAL FIELD

The present application relates generally to a programmable graphics pipeline in a GPU (graphics processing unit) and more particularly to the implementation of a subdivision and storage scheme for vertex data.

### BACKGROUND

Computer graphics processing systems process large amounts of data, including texture data, among others. A texture is a digital image, often rectangular, having a (u, v) coordinate space. The smallest addressable unit of a texture is a texel, which is assigned a specific (u, v) coordinate based on its location. In a texture mapping operation, a texture is mapped to the surface of a graphical model as the model is rendered to create a destination image. In the destination image, pixels are located at specific coordinates in the (x, y) coordinate system. The purpose of texture mapping is to provide a realistic appearance on the surface of objects. In computer graphics, tessellation is commonly used to manage datasets of polygons and to divide polygons into suitable structures for rendering. In many real-time applications, the data is tessellated into triangles, also known as triangulation. Three dimensional (3D) objects are divided or tessellated into a mesh of smaller objects or primitives. The tessellation of surfaces is desirable since surfaces can be modeled with a number of control points. Such operations, however, are bandwidth and memory intensive.

### SUMMARY

Briefly described, one embodiment, among others, is a method for storing vertex data in a graphics processor. The method comprises receiving a patch to be tessellated, subdividing the patch into a plurality of triangles, and identifying control points of each of the plurality of triangles. The method further comprises assigning an identifier to each of the vertices, and selectively storing only a portion of the vertices in a memory.

Another embodiment is a graphics processing unit (“GPU”) having a tessellator in a graphics pipeline configured to subdivide and store a patch, The GPU comprises triangulation logic configured to receive tessellation factors from a hull shader within the graphics pipeline, wherein the triangulation logic is further configured to subdivide the patch into triangles primitives defined by a plurality of vertices according to the tessellation factors. The GPU further comprises vertex generation logic configured to assign control point identifiers to each of the control points of the triangle primitives generated by the triangulation logic and a topology module configured to derive topological information associated with the patch and forward the information to a primitive assembly block.

Another embodiment is a tessellator in a GPU. The tessellator comprises logic configured to receive tessellation factors from a hull shader, wherein the logic is further configured to subdivide a patch into triangles defined by a plurality of vertices according to the tessellation factors. The patch comprises either a quad or a triangle. The tessellator further comprises logic configured to assign an index to each of the control points and logic configured to store only a portion of the control points in a vertex buffer based on symmetric attributes of the subdivided patch.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates a block diagram of a computer system in which embodiments described may be implemented.

FIGS. 2A-B provide a block diagram illustrating certain components or stages of a graphics pipeline 200 within the GPU 110 in FIG. 1.

FIG. 3 depicts various components of the tessellator 242 in FIG. 2A.

FIGS. 4A-B illustrate the processing of patches to be subdivided.

FIG. 5 depicts the location of vertices in the quad patch depicted in FIGS. 4A-B.

FIG. 6 depicts the vertex generation order for the quad in FIGS. 4A-B.

FIG. 7 illustrates the topology of the quad patch in FIGS. 4A-B.

FIGS. 8-9 illustrate the symmetric properties of the quad patch in FIGS. 4A-B.

FIG. 10 depicts a top-level flow diagram of an embodiment for subdividing and storing control points implemented in the system in FIG. 1.

### DETAILED DESCRIPTION

Having summarized various aspects of the present disclosure, reference will now be made in detail to the description of the disclosure as illustrated in the drawings. While the disclosure will be described in connection with these drawings, there is no intent to limit it to the embodiment or embodiments disclosed herein. On the contrary, the intent is to cover all alternatives, modifications and equivalents included within the spirit and scope of the disclosure as defined by the appended claims.

As known to those skilled in the art, the use of Catmull-Clark subdivision surfaces has become a useful tool for modeling due to the ability to construct smooth surfaces with minimal effort. A mesh is subdivided to obtain a new, smooth version of the original shape. Generally, meshes are represented as a series of surface patches. Moving the vertices of the coarse mesh affects the shape of the smooth surface. Embodiments are described for subdividing patches within a tessellator and for efficiently storing information associated with the tessellation process to reduce memory storage requirements.

One embodiment, among others, is directed to a method for storing vertex data in a graphics processor. The method comprises receiving a patch to be tessellated, subdividing the patch into a plurality of triangles, and identifying vertices of each of the plurality of triangles. The method further comprises assigning an identifier to each of the vertices, and selectively storing only a portion of the vertices in a memory. Another embodiment comprises a tessellator in a graphics processing unit. The tessellator comprises logic configured to receive tessellation factors from a hull shader, where the logic is further configured to subdivide a patch into triangles defined by a plurality of vertices according to the tessellation factors, where the patch may comprise either a quad or a triangle. The tessellator further comprises logic configured to assign an index to each of the vertices and logic configured to store only a portion of the vertices in a vertex buffer based on symmetric attributes of the subdivided patch.

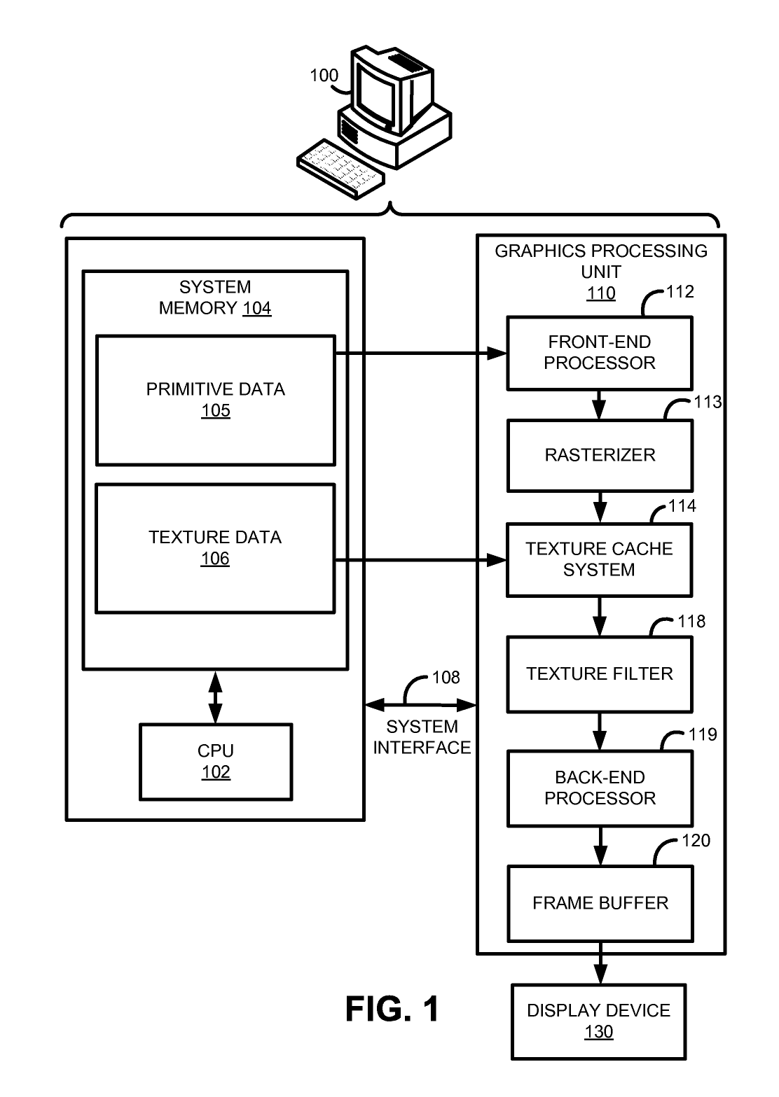

Reference is made to FIG. 1, which illustrates a simplified block diagram of a computer system 100 in which embodiments described herein may be implemented. The computer system 100 includes a CPU 102, a system memory 104 and a graphics processing unit 110. The CPU 102 performs various functions, including determining information, such as a viewpoint location, which allows for the generation of 3D graphic images. The system memory 104 stores a variety of data, including graphics primitive data 105, display data, and texture data 106.

The graphics processing unit 110 receives information determined by the CPU 102 and data stored in the system memory 104, then generates display data for a display device 130, such as, for example, a monitor. Graphics processing unit 110 renders primitives (triangle mesh), thereby composing a 3D object. The triangle mesh forms an object which is further rasterized to create a pixel image of the 3D object. Texture mapping is used to apply textures to objects. Once a 3D object raster image is created, the texture is applied to the object to form a realistic, final image.

The CPU 102 provides requests (e.g., creates display lists and buffers) to the graphics processing unit 110 over a system interface 108, where such requests include requests to process and display graphics information. These requests may be associated with primitive processing buffers that include vertex data and state information. Graphics requests buffered from the CPU 102 are parsed by the graphics processing unit 110 and provided to a front-end processor 112. The front-end processor 112 generates a vertex stream containing transformed vertex coordinates. Information relating to the vertex coordinates generated by the front-end processor 112 is provided to the rasterizer 113, which maps them to 2D image space (on the screen) and generates pixels covering primitives in screen space with hidden surface removal tests. Attributes of primitive vertices such as color and texture coordinates is then interpolated across primitive pixels. Interpolated texture coordinates are used to fetch texture data from memory to the texture filter 118 through a texture cache system 114. The texture cache system 114 receives the information from an interpolation unit (not shown) and fetches the texture data stored in cache memory.

The texture filter 118 then filters the information performing, for example, bilinear filtering, trilinear filtering, or a combination thereof, and generates texture data for each pixel. In addition to conventional texture filter components, such as linear interpolators and accumulators, the texture filter 118 also includes a programmable table filter for providing special filtering operations in conjunction with the other texture filter components. The texture data 106 is a component of the final color data that is sent to a frame buffer 120, which is used to generate a display on the display device 130.

The texture cache system 114 may include multiple caches, including, for example, a level 1 (L1) cache and a L2 cache. The texture information is stored as individual texture elements known as texels, which are used during graphics processing to define color data displayed at pixel coordinates. The texture data 106 flows from the system memory 104 to the texture cache system 114, and then to the texture filter 118, and on to a back-end processor 119. The back-end processor 119 performs pixel-level processing, which includes such functions as texturing, pixel shading, and image merging with the frame buffer 120.

Generally speaking, the computer system 100 in FIG. 1 may comprise any one of a wide variety of wired and/or wireless computing devices, such as a desktop computer, portable computer, dedicated server computer, multiprocessor computing device, and so forth. In addition to the CPU 102 and system memory 104, the computer system 100 may further comprise a number of input/output interfaces, a network interface, display device 130, and mass storage, wherein each of these devices are connected across a data bus. The CPU 102 can include any custom made or commercially available processor, an auxiliary processor among several processors associated with the computer system 102, a semiconductor based microprocessor, one or more application specific integrated circuits (ASICs), a plurality of suitably configured digital logic gates, and other well known electrical configurations comprising discrete elements both individually and in various combinations to coordinate the overall operation of the computing system.

The system memory 104 can include any one or a combination of volatile memory elements (e.g., random-access memory (RAM, such as DRAM, and SRAM, etc.)) and nonvolatile memory elements (e.g., ROM, hard drive, CDROM, etc.). The system memory 104 typically comprises a native operating system, one or more native applications, emulation systems, or emulated applications for any of a variety of operating systems and/or emulated hardware platforms, emulated operating systems, etc. One of ordinary skill in the art will appreciate that the system memory 104 can, and typically will, comprise other components which have been omitted for purposes of brevity. The input/output interfaces described above provide any number of interfaces for the input and output of data. For example, where the computer system 102 comprises a personal computer, these components may interface with a user input device, which may be a keyboard or a mouse.

Where any of the components described above comprises software or code, the same can be embodied in any computer-readable medium for use by or in connection with an instruction execution system such as, for example, a processor in a computer system or other system. In the context of the present disclosure, a computer-readable medium can be any tangible medium that can contain, store, or maintain the software or code for use by or in connection with an instruction execution system. For example, a computer-readable medium may store one or more programs for execution by the CPU 102 described above. The computer readable medium can be, for example, but not limited to, an electronic, magnetic, optical, electromagnetic, infrared, or semiconductor system, apparatus, or device. More specific examples of the computer-readable medium may include the following: an electrical connection having one or more wires, a portable computer diskette, a random access memory (RAM), a read-only memory (ROM), an erasable programmable read-only memory (EPROM, EEPROM, or Flash memory), and a portable compact disc read-only memory (CDROM).

With further reference to FIG. 1, the network interface device described above comprises various components used to transmit and/or receive data over a network environment. By way of example, the network interface may include a device that can communicate with both inputs and outputs, for instance, a modulator/demodulator (e.g., a modem), wireless (e.g., radio frequency (RF)) transceiver, a telephonic interface, a bridge, a router, network card, etc.).

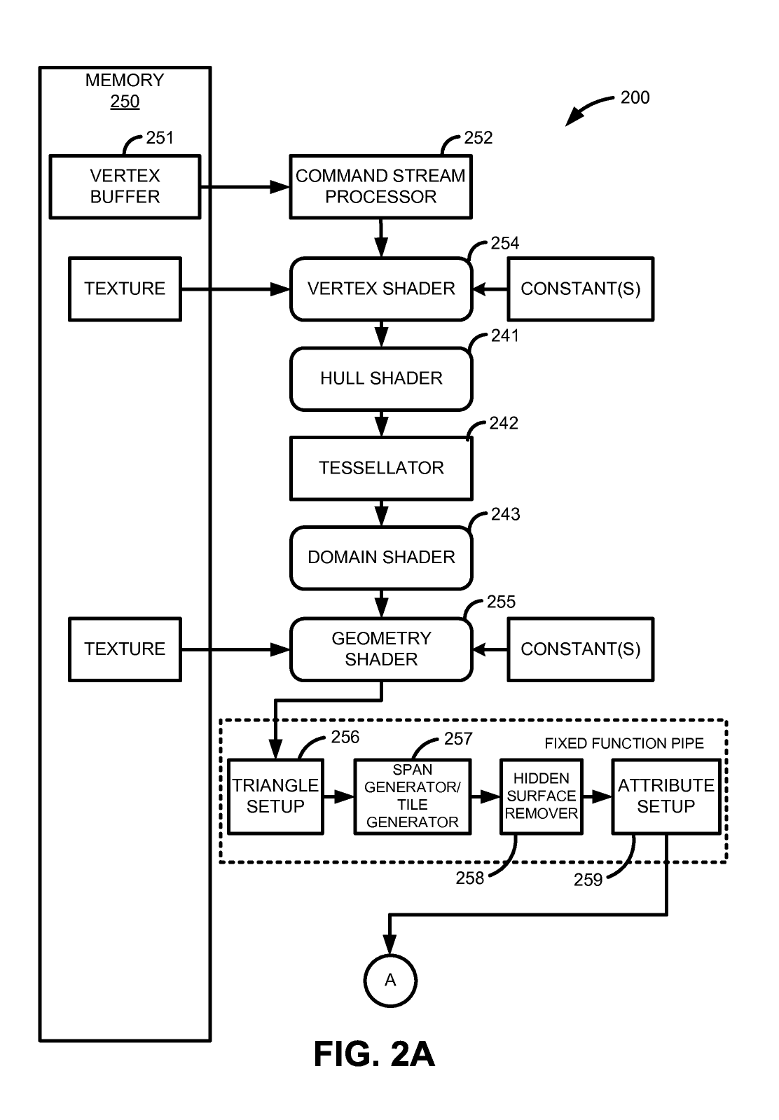

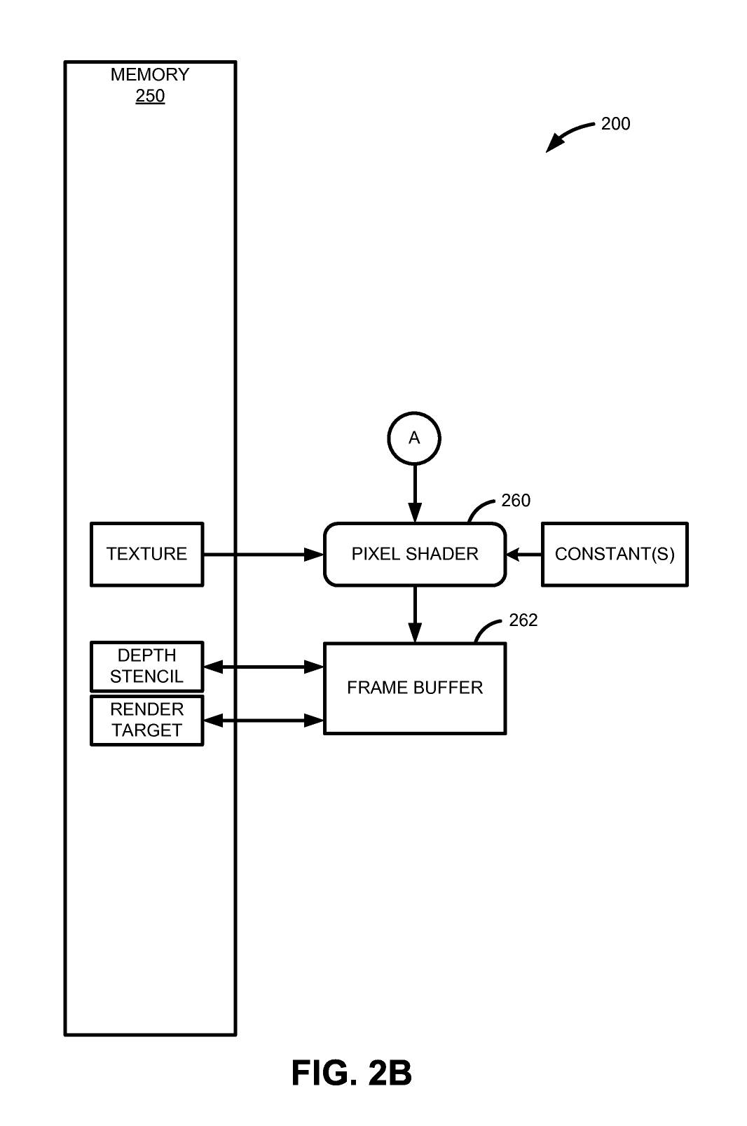

Reference is now made to FIGS. 2A-B which provide a block diagram illustrating certain components or stages of a graphics pipeline 200 within the GPU 110 in FIG. 1. The GPU 110 includes a command stream processor 252, which reads vertices from memory 250. The vertices are used to form geometry primitives and create working items for the pipeline. In this regard, the command stream processor 252 reads data from memory 250 and from that data generates triangles, lines, points, or other primitives to be introduced into the pipeline. This geometry information, once assembled, is passed to the vertex shader 254.

The vertex shader 254 processes vertices by performing operations such as transformations, skinning, and lighting. The GPU 110 further comprises a hull shader 241, a tessellator 242, and a domain shader 243 for performing tessellation. Generally, the function of these shaders 241, 242, 243 is to enhance smoothness on a given surface. A more detailed surface can be constructed from quads, triangles, or isoline patches. Each patch is subdivided into triangles, lines or points using tessellation factors. In short, the hull shader 241 deals with selection of control points of a curve for the given surface and is called for each patch, using the patch control points from the vertex shader 254 as inputs. Among other functions, the hull shader 241 computes tessellation factors, which are passed to the tessellator 242. This allows for adaptive tessellation, which can be used for continuous or view-dependent LOD (level of detail). The tessellation factors are specified per patch edge, and range from 2 to 64. This means that each edge of the patch may be split into at least 2 (and as many as 64) triangle (or quad) edges.

The tessellator 242 uses the tessellation factors to tessellate (subdivide) a patch into multiple triangles. Generally, the tessellator 242 does not have access to the control points. Tessellation decisions are made based on configuration and the tessellation factors passed on from the hull shader 241. Each vertex resulting from the tessellation is output to the domain shader 243. The tessellator 242 also computes (u, v, w) values of the plane, and the domain shader 243 combines the curve onto the plane. A primitive is subdivided into smaller primitives to provide better resolution, which in turn, provides better visual quality. Various control points are set for applying parameters/functions to the primitive so that the primitive can be processed in more detail.

The data from the domain shader 243 is passed to the geometry shader 255. The geometry shader 255 receives, as inputs, vertices for a full primitive, and is capable of outputting multiple vertices that form a single topology, such as a triangle strip, a line strip, point list, etc. The geometry shader 255 may be further configured to perform the various algorithms, such as tessellation, shadow volume generation, etc. The geometry shader 255 outputs information to a triangle setup stage 256, which, as is known in the art, performs operations such as triangle trivial rejection, determinant calculation, culling, pre-attribute setup KLMN-coefficients, edge function calculation, and guardband clipping. The operations necessary for a triangle setup stage should be appreciated by one of ordinary skill in the art and need not be described further. The triangle setup stage 256 outputs information to the span and tile generator 257. This stage of the graphics pipeline is also known in the art and need not be discussed in further detail.

If a triangle processed by the triangle setup stage 256 is not rejected by the span and tile generator 257, hidden surface removal performed by hidden surface remover 258, or other stage of the graphics pipeline, then the attribute setup stage 259 of the graphics pipeline will perform attribute setup operations. The attribute setup stage 259 generates the list of interpolation variables of known and required attributes to be determined in the subsequent stages of the pipeline. Further, the attribute setup stage 259, as is known in the art, processes various attributes related to a geometry primitive being processed by the graphics pipeline.

The pixel shader 260 is invoked for each pixel covered by the primitive that is output by the attribute setup stage 259. As is known, the pixel shader 260 operates to perform interpolations and other operations that collectively determine pixel colors for output to a frame buffer 262. The operations of the various components illustrated in FIG. 2 are well known to persons skilled in the art, and need not be further described herein. Therefore, the specific implementation and operation internal to these units need not be described herein to gain and appreciate a full understanding of the present invention.

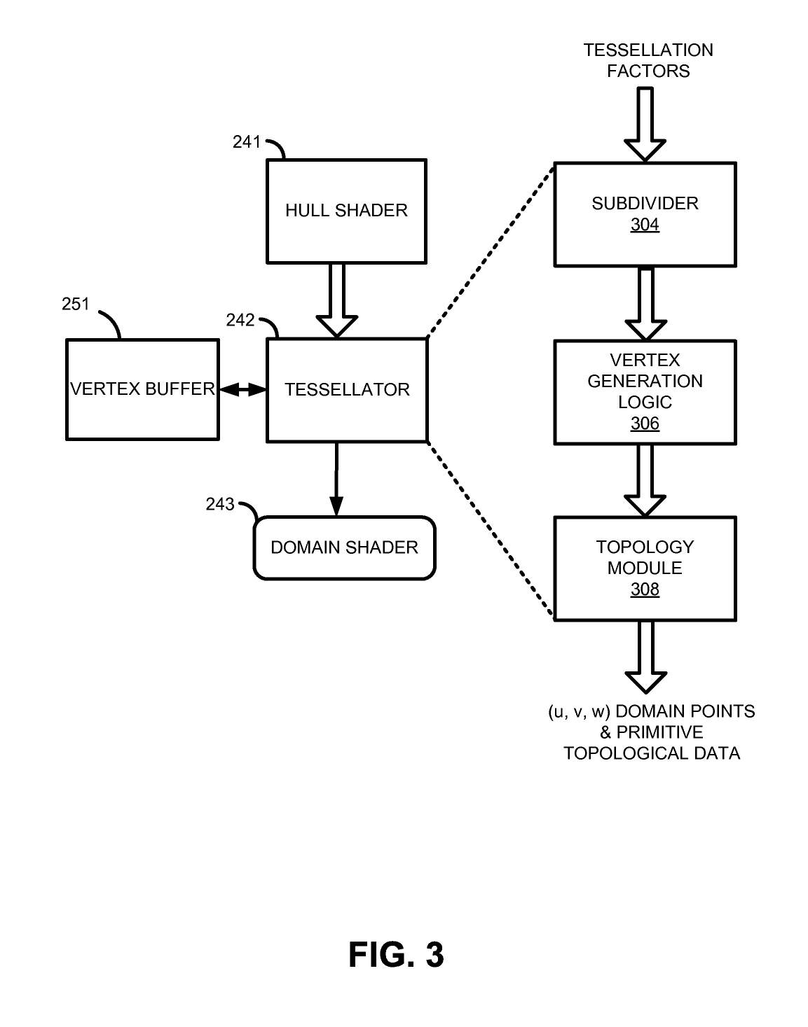

FIG. 3 depicts various components of the tessellator 242 in FIG. 2A. The tessellator 242 may be a fixed function logic, while the hull shader 241 and domain shader 243 are programmable. In accordance with some embodiments, the tessellator 242 may comprise triangulation logic 304 for receiving tessellation factors from the hull shader 241 and subdividing a patch into smaller triangles with associated vertices. The tessellator 242 further comprises vertex generation logic 306 for assigning vertex references to each of the control points of the triangles generated by the triangulation logic 304. The topology module 308 in the tessellator 242 is configured to derive topological information associated with a patch and to forward the information to a primitive assembly block. The topology module 308 also outputs (u, v, w) domain points to the domain shader 243. The topology module 308 is further configured to determine which vertices are saved to the vertex buffer 251 such that only a portion of the vertices are saved and used to derive the remaining vertices. In this regard, the topology module 308 reduces the memory storage requirements for storing vertex data.

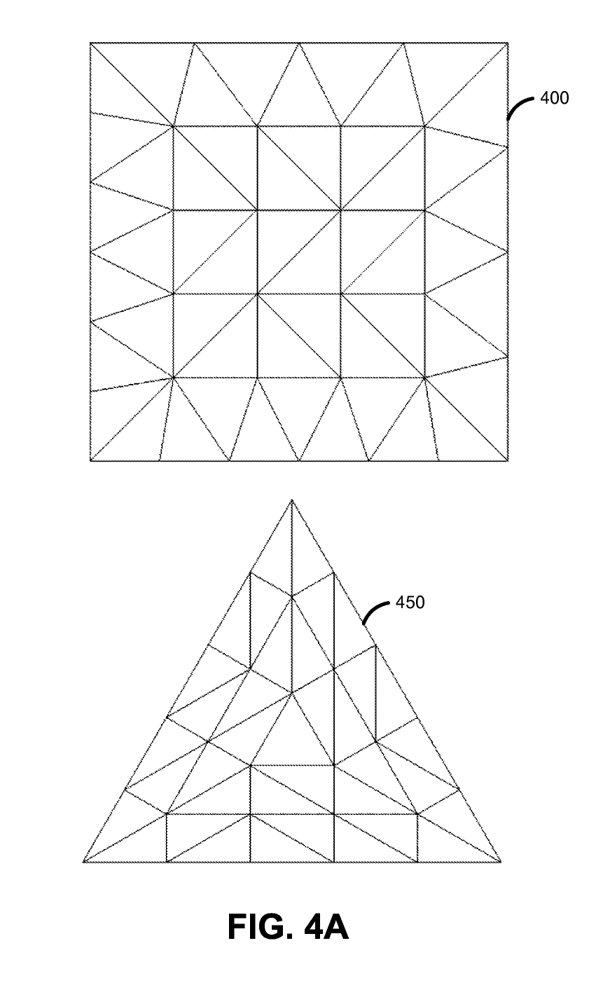

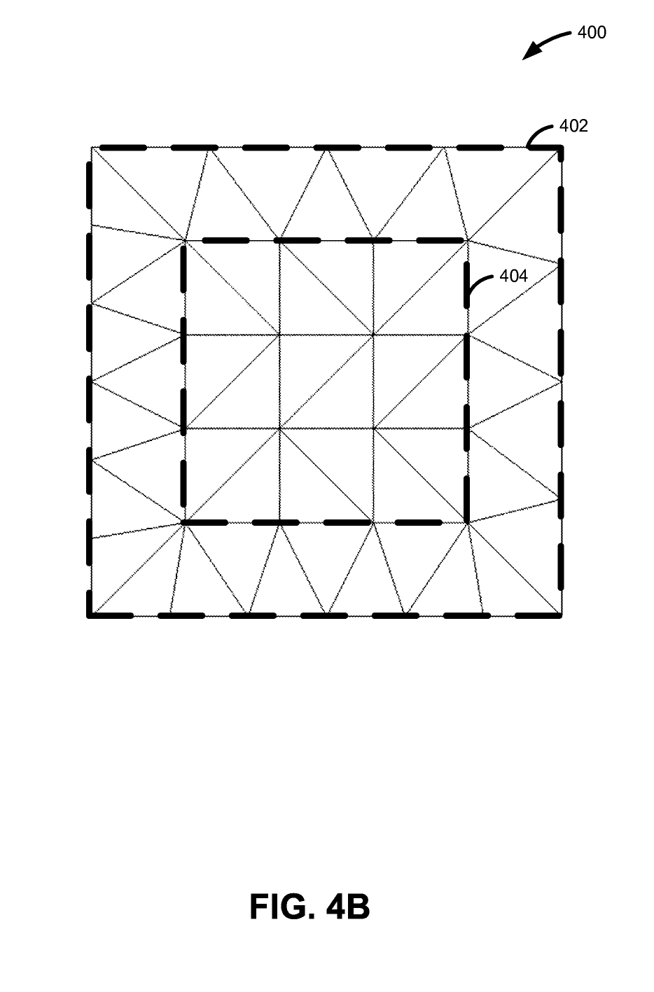

Reference is now made to FIGS. 4A-B, which illustrate the subdivision of patches. In accordance with some embodiments, patches such as quads 302 or triangles 304 first undergo triangulation, as shown in FIG. 4A. With reference to FIG. 4B, the quads 302 or triangles 304 are then subdivided such that an exterior ring 402 and an interior ring 404 of triangles are formed. A quad patch generally has six tessellation factors for specifying the subdivision of the quad patch. In particular, a quad patch has four tessellation factors which are associated with each edge of the exterior edge, and one or two tessellation factors for the interior ring. One tessellation factor may be used for both the vertical axis and horizontal axis. Alternatively, two tessellation factors may be used—one for the vertical axis and one for the horizontal axis of the interior ring.

Generally, tessellation factors specify the degree or level of tessellation to be performed on a given patch. The tessellation factors are used to tessellate or subdivide a given patch into multiple triangles. A triangle patch has four tessellation factors—three factors associated with each edge of the three exterior edges and one factor associated with the interior edges. For a line, there are two tessellation factors. The division of edges of the interior ring 404 is generally fixed while the division of edges of the exterior ring 402 may vary since the resolution of the exterior ring 402 may vary.

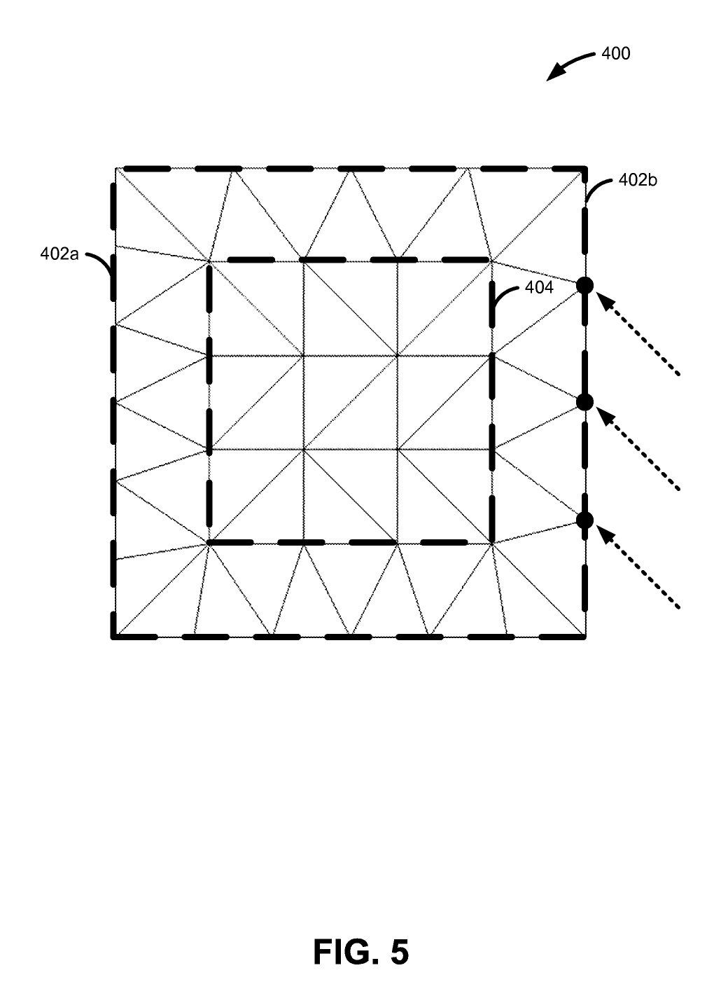

By way of illustration, reference is made to FIG. 5, which depicts the location of vertices or vertices in the quad patch 400 depicted in FIGS. 4A-B. As shown, the quad 400 includes a left edge 402a and a right edge 402b. The left edge 402a has a tessellation factor of 5, whereas the right edge 402b has a tessellation factor of 3. Note that for the interior ring 404, the edges are divided into the same number of parts. In this regard, the resolution can be adjusted through the setup of the outer rings. Generally, the tessellator 242 depicted in FIG. 2A does not have access to control points. Thus, tessellation decisions are made based on the configuration and the tessellation factors passed on from the hull shader 241. Each vertex resulting from the tessellation is output to the domain shader 243.

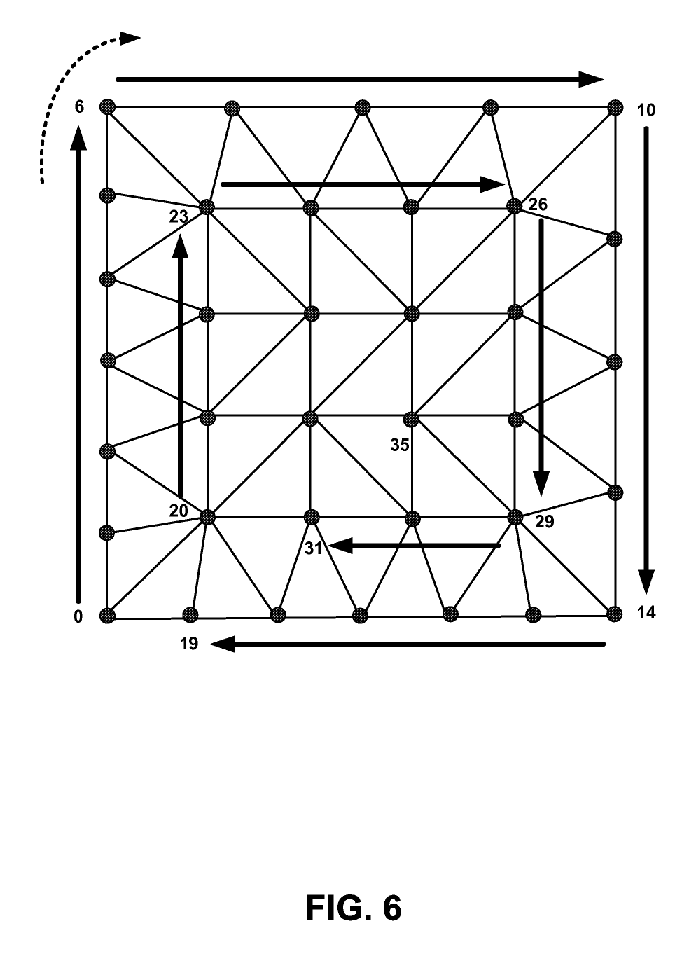

After triangulation is performed, the edge vertices formed by the series of triangles are assigned reference points based on a vertex generation order. Reference is made to FIG. 6, which depicts the vertex generation order for the quad in FIGS. 4A-B. For quad patches, the edge points for the exterior ring are generated beginning with the bottom left vertex, designated as “0.” The edge points are then assigned in a spiraling, clockwise fashion, beginning with the exterior ring and moving towards the inner ring. In the non-limiting example shown in FIG. 6, the last edge point is labeled “35.” A similar vertex generation order is used for triangle patches. Beginning with the bottom left vertex, the reference points are assigned values in a spiraling, clockwise fashion.

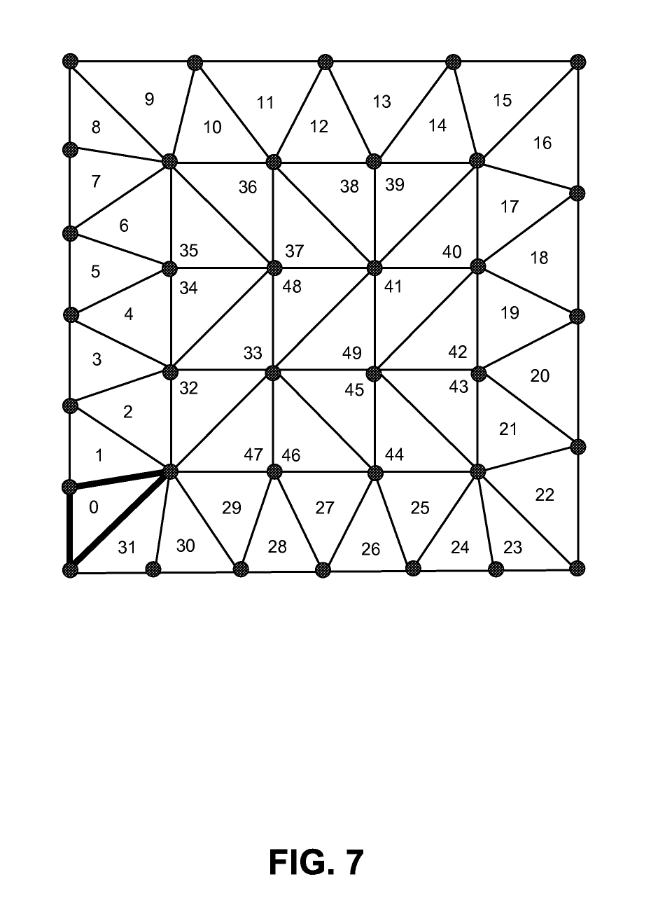

The triangles that make up the patch are then defined based on the assigned vertex references. In this regard, the topology of the patch is defined. With reference to FIG. 7, triangle “0” is defined by vertex (0, 1, 20) based on the point generation scheme discussed above. As other examples, triangle “31” is defined by vertex (0, 19, 20) and triangle “49” is defined by vertex (32, 34, 35). The vertices that define these triangles are typically stored. With conventional approaches, all of the vertices (e.g., 0 to 35) are typically stored in a vertex buffer 251 such as the one depicted in FIG. 2A. As such, as the level of resolution increase, the storage requirements increase as well. Various embodiments are described whereby only a portion of the vertices is saved, thereby providing a substantial reduction in memory storage requirements.

Exemplary embodiments described herein for storing vertices are based on symmetric properties associated with patches. It should be noted that the tessellator 242 provides mirrored point distribution of the various vertices or vertices across each edge. As an illustration, suppose a vertex is located at coordinate “x” along an edge [0 . . . 1]. There is thus a corresponding vertex located at “1-x” as this point mirrors the first coordinate. The subdivision of patches according to various embodiments is based on the symmetric properties resulting from tessellation. As such, a savings in memory storage can be realized when implementing the embodiments described as only half of the vertices need to be saved. The remaining vertices associated with the patch are calculated based on information associated with the saved vertices. The reduction in memory storage requirement will depend in part on whether the resolution varies among the different edges of the exterior ring.

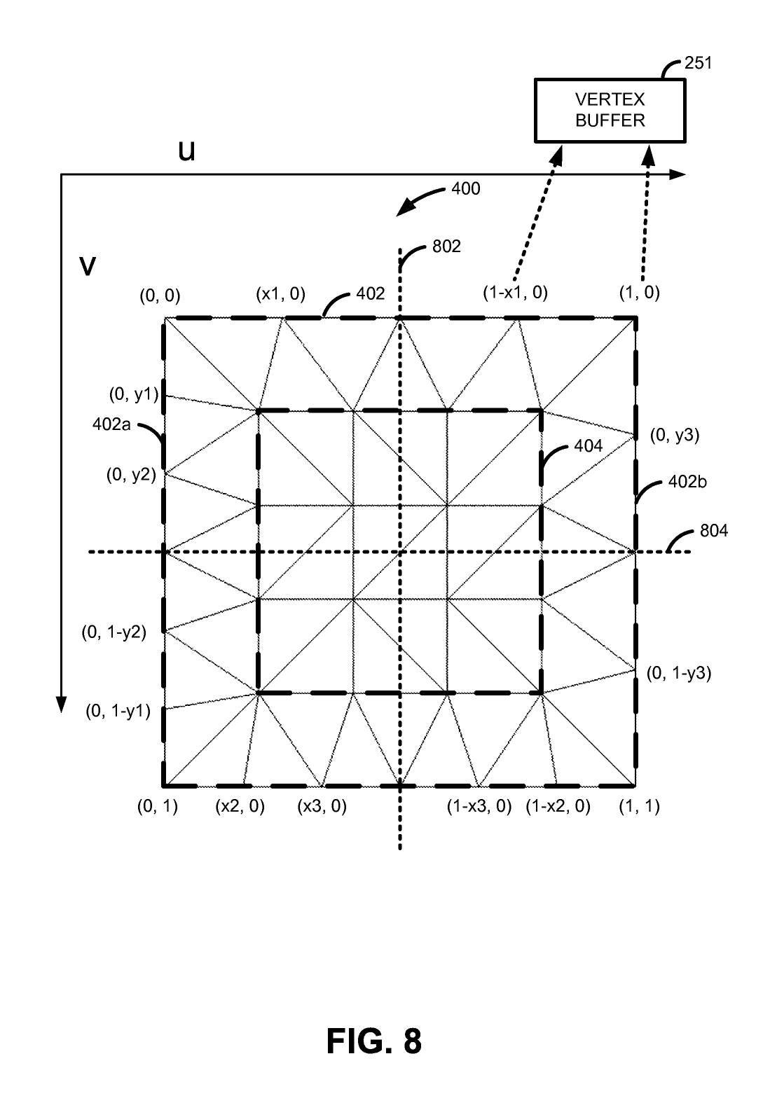

FIG. 8 illustrates the symmetric properties of the quad patch 400 in

FIGS. 4A-B. The vertical dashed line 802 depicted in FIG. 8 represents the axis of symmetry with respect to the left 402a and right 402b exterior edges of the quad 400 depicted in FIG. 4. The vertices along the exterior ring 402 are shown in the (u, v) coordinate space. Also shown are a horizontal “mirror” axis 804 and a vertical mirror axis 802. The locations of vertices along a given edge are symmetric with respect to the axis 802, 804 bisecting that edge. By way of example, the top edge shows a vertex at location (x1, 0). Assuming that the top right corner of the quad 400 is located at (1, 0), it can be determined that the vertex next to the top right corner is located at (1-x1, 0) since the controls points that lie along the top edge are symmetric with respect to the vertical axis 802.

As another example, the left edge 402a shows vertices at (0, y1) and at (0, y2). Assuming that the bottom left corner of the quad 400 is located at (0, 1), it can be determined that the controls next to this corner are located at (0, 1-y1) and at (0, 1-y2). This is based on the assumption that the vertices are symmetric with respect to the horizontal axis 804. Along the right edge 402b, vertices are shown at (0, y3) to emphasize again that the location of vertices along one edge of the exterior ring 402 may differ from those along another edge of the exterior ring 402. As such, the edges of the exterior ring are separately analyzed regarding its symmetric properties.

Based on the symmetry of the location of vertices along the vertical 802 and horizontal axis 804, only a portion of the vertices need to be stored in the vertex buffer 251. As a non-limiting example, only the (u, v) coordinates for the controls points at (1, 0) and (1-x1, 0) along the top edge need to be stored. By retrieving these points, the location of the other vertices along the same edge can be calculated. In this regard, a savings in memory storage requirements can be realized by utilizing the subdividing scheme described. In accordance with exemplary embodiments, only half of the vertices needs to be saved. For example, by saving points (0, 0) and (x1, 0), the remaining vertices can be calculated rather being saved, thereby reducing the amount of memory space that is required.

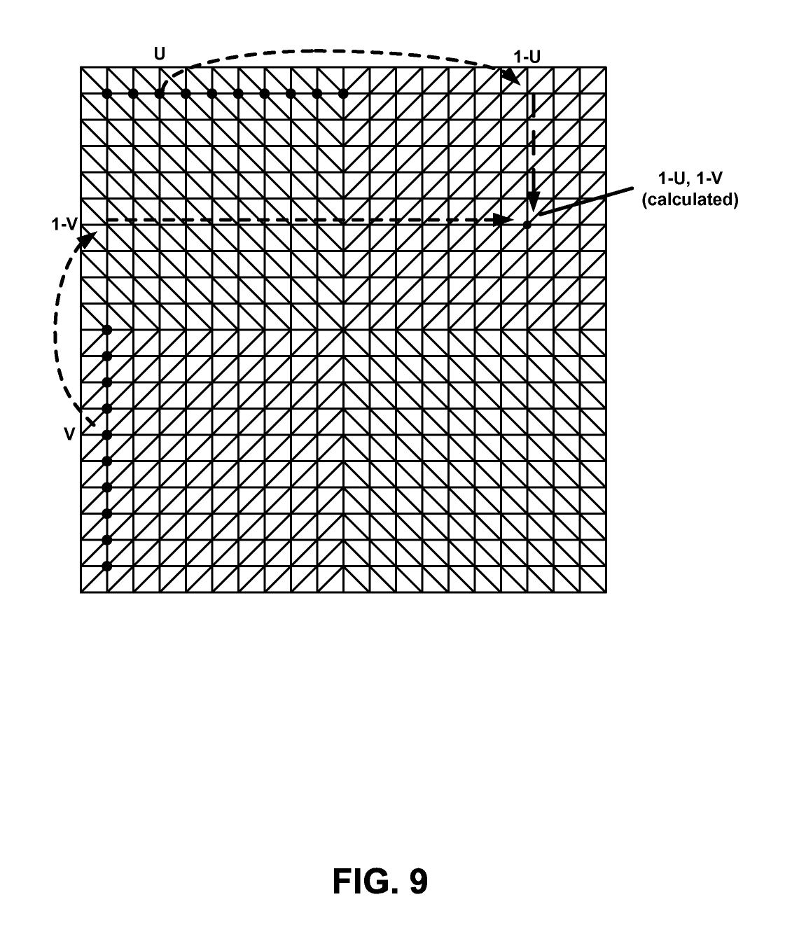

Note again that within the interior ring 404, the locations of vertices along the vertical edges are the same relative to each other. Likewise, the locations of vertices along the horizontal edges are the same relative to each other. In some instances, the location of vertices along all the edges of the interior ring 404 may all be the same relative to each. As such, only one and at most two tessellation factors are needed to represent the vertices or vertices of the interior ring 404. Accordingly, it should be appreciated that only a portion of the vertices need to be saved to memory in order to represent each of the vertices associated with the interior ring. To further illustrate the savings in memory requirements, reference is made to FIG. 9, which depicts a quad patch with 18×18=324 interior vertices. The interior vertices can be stored by merely saving the 20 vertices that are highlighted. In this regard, it should be appreciated that only a small fraction of the interior vertices (20/324=0.617) needs to be saved. As depicted, post-processing can be performed to calculate the remaining vertices based on the saved vertices. While the embodiments above are described in the context of a quad patch, it should be appreciated that the same concepts can be applied to triangle patches as well.

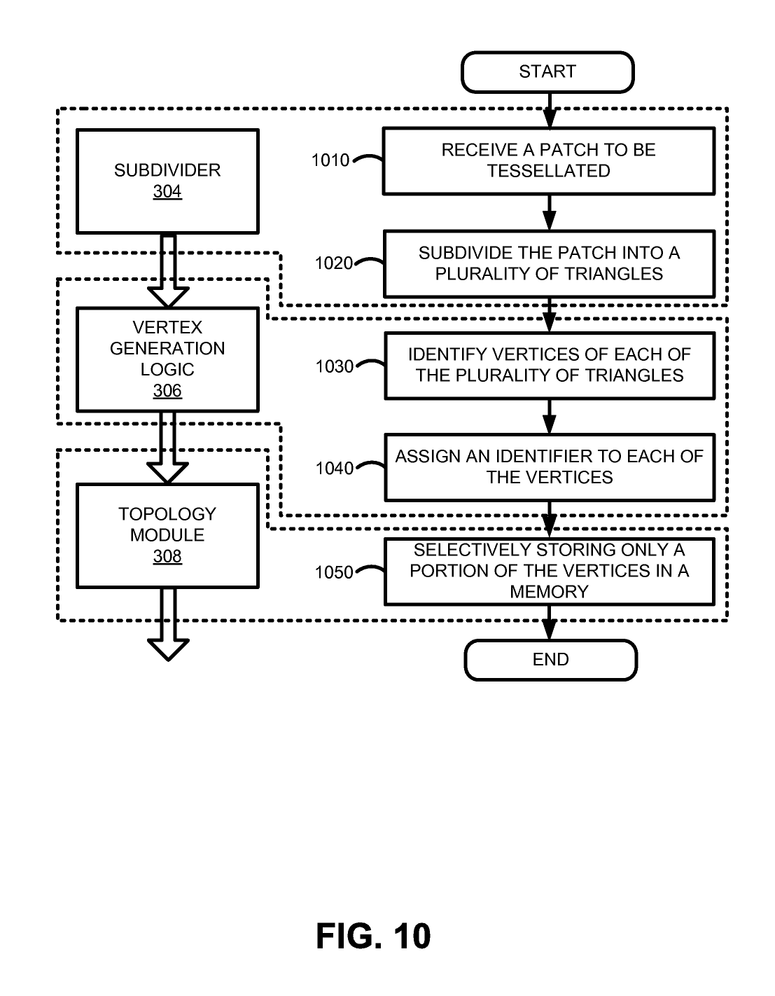

FIG. 10 depicts a top-level flow diagram for an embodiment of a method for subdividing and storing control points implemented in the system in FIG. 1. In block 1010, a patch to be tessellated is received. As described above, the patch may be a triangle or a quad. In block 1020, the patch is subdivided into a plurality of smaller triangles, as illustrated in FIG. 4A. In block 1030, the vertices of each of the plurality of triangles are identified, and in block 1040, an identifier is assigned to each of the vertices. Referring back briefly to FIG. 6, the identifiers are assigned beginning with the bottom left vertex (i.e., the vertex labeled “0”) in the exterior ring.

In block 1050 of FIG. 9, only a portion of the vertices are selectively stored in a memory, such as a vertex buffer. Only a portion of the vertices are stored to reduce memory storage requirements. As described herein, this is based on mirrored point distribution of the various vertices or vertices across each edge of the patch by the tessellator 242 in FIG. 2A. As one of ordinary skill in the art will appreciate, other sequences of steps may be possible, and the particular order of steps set forth herein should not be construed as limitations on the claims. In addition, the claims directed to the method and/or process of various embodiments should not be limited to the performance of their steps in the order written, and one skilled in the art can readily appreciate that the sequences may be varied and still remain within the spirit and scope of the present invention.

It also should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

At least the following is claimed:

1. A method for storing vertex data in a graphics processor, comprising:
receiving a patch to be tessellated;
subdividing the patch into a plurality of triangles;
identifying vertices of each of the plurality of triangles;
assigning an identifier to each of the vertices; and
selectively storing only a portion of the vertices and their corresponding identifiers in a memory.

2. The method of claim 1, wherein subdividing the patch comprises:
forming an exterior ring of triangles comprising a plurality of exterior edges; and
forming an interior ring of triangles comprising a plurality of interior edges.

3. The method of claim 2, wherein vertices on the exterior ring of triangles are equally distributed about a halfway point on the exterior edges such that vertices mirror each other about an axis through the halfway point.

4. The method of claim 2, wherein vertices on the interior ring of triangles are equally distributed about a halfway point on the interior edges such that vertices mirror each other about an axis through the halfway point, and wherein distribution of the vertices among each of the interior edges is constant.

5. The method of claim 3, wherein selectively storing only a portion of the vertices in a memory comprises:
for each exterior edge, storing one half of the vertices on each exterior edge.

6. The method of claim 3, wherein selectively storing only a portion of the vertices in a memory comprises:
for a vertical interior edge and a horizontal interior edge, storing one half of the vertices on the vertical and horizontal interior edges.

7. The method of claim 2, wherein vertices on the interior ring of triangles are equally distributed about a halfway point on the interior edges, and wherein the distribution of the vertices is the same on each of the interior edges.

8. The method of claim 2, wherein assigning an identifier to each of the vertices is performed starting with a bottom left vertex on the exterior ring of the patch and assigning an identifier to each of the vertices in a spiraling, clock-wise fashion.

9. The method of claim 8, wherein assigning an identifier comprises assigning an integer identifier to each of the vertices in a sequential order.

10. The method of claim 1, wherein the memory comprises a vertex buffer.

11. A graphics processing unit (GPU) having a tessellator in a graphics pipeline configured to subdivide and store a patch, comprising:
triangulation logic configured to receive tessellation factors from a hull shader within the graphics pipeline, wherein the triangulation logic is further configured to subdivide the patch into triangles primitives defined by a plurality of vertices according to the tessellation factors;
vertex generation logic configured to assign vertex identifiers to each of the vertices of the triangle primitives generated by the triangulation logic; and
a topology module configured to derive topological information associated with the patch and forward the information to a primitive assembly block.

12. The GPU of claim 11, wherein triangulation logic is further configured to form an exterior ring of triangles comprising a plurality of exterior edges and an interior ring of triangles comprising a plurality of interior edges.

13. The GPU of claim 12, wherein vertices on the exterior edges of the exterior ring are equally distributed about an axis halfway on each of the exterior edges, wherein vertices on the interior edges of the interior ring are equally distributed about an axis halfway on each of the interior edges, and wherein the distribution of vertices is the same on each of the interior edges.

14. The GPU of claim 12, wherein the vertex generation logic is configured to assign vertex identifiers in a spiraling, clock-wise direction beginning with a bottom left vertex on the exterior ring, wherein assigning vertex identifiers comprises assigning an integer identifier to each of the vertices in a sequential order.

15. The GPU of claim 14, wherein the topology module is further configured to save, for each exterior edge, the vertices on one side of the axis located halfway on each of the exterior edges to a vertex buffer, and wherein the topology module is further configured to save, for a horizontal interior edge and a vertical interior edge, the vertices on one side of the axes located halfway on the interior edges to a vertex buffer.

16. The GPU of claim 15, wherein the topology module is further configured to save the identifiers assigned to the saved vertices.

17. A tessellator in a graphics processing unit (GPU), comprising:
logic configured to receive tessellation factors from a hull shader, wherein the logic is further configured to subdivide a patch into triangles defined by a plurality of vertices according to the tessellation factors, wherein the patch comprises one of: a quad and a triangle;
logic configured to assign an index to each of the vertices; and
logic configured to store only a portion of the vertices in a vertex buffer based on symmetric attributes of the subdivided patch.

18. The tessellator of claim 17, wherein the logic configured to subdivide a patch is further configured to partition the subdivided patch into an exterior ring of triangles and an interior ring of triangles, wherein edges of the interior ring comprise equally distributed vertices such that the distribution of vertices on all the edges of the interior ring is the same.

19. The tessellator of claim 18, wherein the logic configured to assign an index to each of the vertices is further configured to assign integer indices in a spiraling, clock-wise direction beginning with a bottom left vertex on the exterior ring, wherein assigning integer indices is performed in a sequential order.

20. The tessellator of claim 18, wherein the logic configured to store a portion of the vertices in a vertex buffer stores:
for each exterior edge, the vertices on one side of the axis located halfway on each of the exterior edges, and
for a vertical interior edge and a horizontal interior edge, the vertices on one side of the axes located halfway on the interior edges to a vertex buffer,
wherein the logic configured to store a portion of the vertices in a vertex buffer is further configured to store the indices assigned to the stored vertices.
